(19) United States
(12) Patent Application Publication
(10) Pub. No.: US 2008/0233542 A1
(43) Pub. Date: Sep. 25, 2008

(54) System for optimising the formation of refractory moulds for multiple metal castings in the production of fixed dental prostheses

(76) Inventor: Jose Luis Martinez Procel, Mexico (MX)

Correspondence Address: JOSE LUIS MARTINEZ PROCEL, CALLE TUXPAN No. 10 - 404 COLONIA ROMA SUR, DELEGACION CUAUHTEMOC, MEXICO, DISTRITO FEDERAL, 06760, M

(21) Appl. No.: 11/979,827

(22) Filed: Nov. 8, 2007

(30) Foreign Application Priority Data
Sep. 5, 2005 (MX) PA/A/2005/004958

(51) Int. Cl. A61C 5/10

(52) U.S. Cl. 433/223

(57) ABSTRACT

According to the invention, the components of the system have been optimised such that they interact and complement each other and such that one cannot operate without the other in the formation of refractory moulds for multiple metal castings in the production of fixed dental prostheses. The invention also relates to a mechanical metal device for positioning increased length refractory cylinders in standard horizontal centrifuges, thereby increasing the number of fixed dental prostheses that can be cast at one time.

### CROSS-REFERENCES TO RELATED APPLICATIONS

COUNTRY APPLICATION NUMBER FILING DATE PRIORITY CLAIMED MEXICO Pa/a/2005/004958 Sep. 5, 2005 Yes

### STATEMENT REGARDING FEDERALLY SPONSORED RESEARCH OF DEVELOPMENT

“Not Aplicable”

### THE NAMES OF THE PARTIES TO A JOINT RESEARCH AGREEMENT

“Not Aplicable”

### INCORPORATION-BY-REFERENCE OF MATERIAL SUBMITTED ON A COMPACT DISC

“Not Aplicable”

### BACKGROUND OF THE INVENTION

(1) Field of the Invention

This invention refers to a system to optimize the procedure to make refractory moulds for multiple metal castings in fixed dental prosthesis, a method to build the refractory moulds and, on the other hand, the system itself and its utilization.

In previous art, we find systems such as the one described by Abraham Cooper in 1972 with the purpose of mounting multiple wax patterns on a vertical plastic dowel; later, the same author in 1979 designs a support pattern with a T form in two levels with the same purpose; he also shows a base with a lateral fixture designed to be adjusted to a hollowground sprue which connects with two flanges that divide the casting ring laterally to dismount the refractory cylinder.

As to the design of the support for the fixed bridge wax patterns, it consists traditionally of a horizontal bar that connects to the wax patterns by means of wide wax connectors or sprues; on the opposite side two oblique bars are directed to the base.

Years later, the so called “oval casting system” gets into the market, it also includes a T bar design, an oval casting ring and a fixture to adapt the short oval casting ring to the centrifuge, later, plastic vases are used with the T bar system.

Benefit

The solicitant has developed a novel system for multiple metal castings, solving the many problems associated with the current existing systems; following, a detailed description of the terms used in this technique for a better understanding.

(2) Background Art

Induction to the system to optimize the manufacture of refractory moulds for the fabrication of multiple metal castings in dental prostheses

Motivation to improve the casting systems in conventional centrifugal machines with pivoted arm.

The motivation to find a different casting system to those utilized in the 1950-1960 is founded in the failures i had while as a student the hand held centrifugal bow was used to cast single prostheses, after graduation in 1958 at the Universidad Nacional Autonoma de Mexico, the dental bridges were sent to several commercial laboratories that were incapable of delivering properly fitting structures, when I complained about the poor results they told me that If I knew how to cast accurately then I had to demonstrate. I humbly and enraged accepted the challenge with nothing but my youth and enthusiasm and began to design different kinds of supports or crucible formers based on observation, in logic and fundamental knowledge as I knew nothing about the physics and chemistry relative to casting, crystallization, thermodynamics, flow mechanics, mechanics and centrifugal forces that are intermingled in the casting procedure.

After thousands of experiments and several years of research with special attention to the analysis of success and failures I obtained excellent results with the design of the crucible formers that were not much different to the actual ones but that were hand made in wax and it was time consuming.

Years later I decided to create an injection mould with solid plastic material in the A and B supports and the coupling attachments were made with extrusion moulds, soon I noticed that the refractory cylinders were fracturing during the burn-out process due to the thermal expansion differences between the refractory material and the plastic formers making it necessary to coat the supports with wax to avoid fractures; then, another problem arose, as the cylinders became longer in order to allow for more prostheses to be cast they didn't fit in the conventional holders of the centrifugal pivoting arm casting machines so I invented a metal-mechanic appliance to convert this machine in a special centrifugal machine that allowed the new system to be used with no change at all in the original mechanic and functional characteristics.

Years later I made an injection mould for the type A and B supports with a hollow stem to avoid the fracture of the refractory material during burn-out, I also designed a vase with special characteristics to improve its function; once I had completed the whole system and proving it thousands of times I went to the School of Engineering and the School of Chemical Engineering at the National University of Mexico, there, my system was approved by experts in the subject and reminded me that in order to scientifically sustain my project it was necessary to study all the physics and chemistry subjects without any reference to the dental articles and papers because all of the existing support systems are designed in a T bar fashion.

In 1967, at LomaLinda University a dynamic radiofluoroscopic motion picture showed some of the principles and rules but the understanding of all the defects in the castings is limited, the porosity, the flowback and the incomplete filling of the mould are due to multiple causes, the T bar among them because it has a perpendicular bar as a reservoir that receives a hard impact of the molten alloy that frequently chip pieces of the fragile refractory material and, due to its low density the chips remain in that zone so that bar also acts as a trap, another defect of the T bar is that the perpendicular bar is not well oriented in the cylinder because both ends of the bar get away from the thermal zone considering that the hot zone in a refractory cylinder is within and near the geometrical axis, another deleterious factor is the ignorance of the fluid mechanics, a subject that is to be learned not from dental literature but in engineering papers, having known this well before I could have saved years of experimentation.

In 1980, Volume 2 of Quintessence Book on Bridge Design and Laboratory Procedures, John W. McLean and other authors do not approve de T bar design (p. 227-236) and describe accurately the thermal zone (p. 228), shows the convenience for a constriction of the sprue in the joint to the pattern and the location of the patterns within the vase, although violating the rules that he himself describes (p. 219 and 224). In 1990 the book Precision Fixed Prosthodontics Clinical and Laboratory Aspects by Dr. Martignoni and the Dental Technician G Lattburg, Quintessence Books written and showing both extraordinary methodology and statistics is wrong in stating that only half of the refractory cylinder is adequate for a proper filling of the alloy in the mould due to the centrifugal and centripetal resultant forces.

Another of the important readings is Beely's Foundry Technology, it considers all of the subjects before mentioned and also the authorized spanish version of Julian Szekely's Fluid Flow Phenomena in Metal Processing Academic Press Inc. Isbn Massachusetts Institute of Technology.

When lecturing I begin showing the failures with different kinds of designs, then I explain the thermodynamics of an apple at determined temperatures and times in an oven, the skin and central temperatures of the apple are exactly the same but, when it is taken out from the oven the loss of heat occurs from the exterior and to the core, the geometric center of the apple and a spheric zone near to it is the thermal or hot zone, and asking then about a cylinder that is removed from the oven the most frequent answer is that the thermal zone is the geometrical axis, adding to this that the molten alloy enters via the cylinder crucible access and the mould is filled staying longer in a liquid as John McLean suggests whilst the alloy in the pattern moulds nearer to the surface begin to crystallize resulting in a directional guided crystallization ensuring that there is always molten alloy at the stem guaranteeing a continues flow towards the external walls of the cylinder and avoiding the backflow of the alloy in the patterns due to the centrifugal forces. As to the fluid flow I ask as an analogy what happens when a water hose is directed to the floor and everybody answer that it will splash and our pants and shoes will get wet, this is what is called a turbulent flow; on the other hand if we position the hose in the floor the water will flow smoothly without splashing forming a laminar or layering flow; as to the placement of the sprue in relation to the pattern, something that I consider of the utmost importance in this claimed invented system I ask the audience what happens if we diminish the diameter of the hose end and they answer that the water flow will get farther, that is, the speed of the flow will increase without changes in the water pressure. If we correlate the angle of the attachment to the wall of the pattern with the mentioned concepts where form and function are indivisible and then highlighting the design of a bevel in the type a attachment in a tangential position thus ensuring that the molten alloy will fill the pattern mould with a soft but fast flow.

In this way, the audience is understanding by themselves, getting to conclusions and reasoning and accepting the merits and advantages of this system and getting knowledge in an area, that has not advanced for many years, assuring that predictable results can be achieved with this claimed invented system, at a lower cost, time efficiently and with a lower contamination of the environment.

### BRIEF SUMMARY OF THE INTENTION

Essentially, the objectives of this invention are based upon the disadvantages of the existing techniques, as follows.

To avoid the loss of physical properties of the alloy referring to: fracture resistance, modulus of elasticity, elongation, etc.

It is the purpose of this invention to avoid defects in the outcoming casting such as porosities, tears, imprecision, and blunt or incomplete margins as well.

It is also the objective of this invention to solve the problems derived from the subutilization of the space of the refractory vase, which counts for a great amount of refractory material and alloy waste, all of this will be discussed further in great detail. Electrical energy costs will also be reduced, as well as grinding and cutting implements, working time and environmental contamination.

This invention has been developed following strictly the physical principles of melting, casting, fluid behaviour, thermodynamics, and metallurgy

The results obtained have been outstanding and excellent

There are many techniques to elaborate fixed metal dental prostheses, they involve different designs to provide spruing to the wax patterns, so many criterion related to the type of material, width and longitude, site of placement of the sprue, angles and location within the casting ring; all of this making a confusing time for the technician and providing non consistent and non confident results adding to a great waste in materials and working time.

### BRIEF DESCRIPTION OF THE SEVERAL VIEWS OF THE DRAWINGS

FIG. 1 A diagram showing the flow of the refractory mould former for metal castings

FIG. 2 A perspective view of a straight bridge pattern seated on the master dies with the connectors attached to the male fixtures of the type A support

FIG. 3 A perspective view of the type A support with many straight bridge patterns mounted in it and attached to the crucible former cone

FIG. 4 A perspective view of the type A support with mounted patterns, fixed to the crucible former and attached to the flask ring

FIG. 5 A perspective view of the refractory mould showing the crucible form

FIG. 6 An upper perspective view of a section of the conventional centrifuge with the installed metal-mechanical converter. The extension thus obtained is observed

FIG. 7 An upper perspective view of the conventional centrifuge with its covered notch obtaining the original mechanical and functional conditions and characteristics

FIG. 8 A frontal, lateral, upper and lower view of the type A support

FIG. 9 A frontal view of the type A support with a straight bridge 5 unit pattern and 2 single patterns

FIG. 10 A frontal view of a beveled female type (a) attachment

FIG. 11 A lateral view of a pattern in its working die

FIG. 12 A lateral view of a single pattern with a little wax bulge below the incisal edge

FIG. 13 A lateral view of the female attachment joined to the before mentioned bulge

FIG. 14 A view showing the connection of the single pattern still in the working die trough

the female attachment with the support male

FIG. 15 A view showing how the working die is dislodged from the pattern

FIG. 16 A frontal, lateral, upper and lower view of the type B support

FIG. 17 A frontal view of a beveled female attachment as a curved fixing element 20

FIG. 18 A lateral view of a type B support after being bent into an arc. The type B attachment in its place

FIG. 19 A frontal view of the type B support on a curved bridge pattern to calculate the arc of the support

FIG. 20 A frontal view of the type B support with the male attached to the connectors with wax to the curved bridge pattern

FIG. 21 A view of the joint of the support in the crucible former notch

FIG. 22 A view of the type B support with the type (b) attachment securing the stability of the curvature in a curved bridge pattern, the support is mounted in the crucible former

FIG. 23 A view of the type B support with a curved bridge pattern and single units mounted as well

FIG. 24 A view of a not bent type B support with two straight bridge patterns and single units in the flask

FIG. 25 A lateral view of the crucible former showing the holding flanges and the upper end of the cone

FIG. 26 An upper view of the crucible former showing the cone, the notch, the domes and a channel in its inner surface

FIG. 27 A view of the ring with opposite pointed flanges and a straight angle step that diminishes the profile and below it has a relief to be inserted in the crucible former notch

FIG. 28 An upper view of the ring holding a type B support with a curved bridge pattern mounted, the support is inserted in the crucible former and the ring is forming the vase as it is fixed in it

FIG. 29 A view of the refractory cylinder crystallizing in the flask, once dismounted, it shows the crucible with the negative cone of the crucible former, a section of the support stem and two channels opposed one to another

FIG. 30 An upper view of a section of the conventional centrifuge with the crucible in its plate and a conventional short cylinder (60 mm) in the holder. It is supported in the flanged vertical plaque

FIG. 31 A frontal view of the template to fabricate a notch in the vertical plaque to provide external support to the cylinder in conventional centrifuges

FIG. 32 An upper view without the cylinder holder, showing in the outer side the fixed replica in the screw channels, the machined notch in the original plaque, the arm of the centrifuge and the crucible

FIG. 33 A frontal view of the perforated flanges plaque

FIG. 34 An upper view of the centrifuge with the cylinder holder in the screws

FIG. 35 An upper view of a long cylinder (80 mm) in the holder, trough the notch and supported by the replica

FIG. 36 A frontal view of the circular metallic plaque with inferior extensions to be mounted in the rails to block the notch. This gives back the original functional and mechanical characteristics.

### DETAILED DESCRIPTION OF THE INVENTION

Terminology

We have no Universal terms in the field of lost-wax casting technique, every country utilize local terms, hence, the terminology as used in the United States of America will be used as I consider to be an accurate and correct one.

Pattern. It is the wax or plastic model of a unit or many units joined together to be reproduced in metal alloy. It can be a coping, an inlay, onlay, full crown, a bridge or a splint.

Single pattern. It is a unit, and it is named as such to differentiate from complex structures composed by two or more patterns.
To model: To give form to a plastic material
Pontic: Is the model of an absent tooth
Master Cast: Is a replica of the teeth and soft tissues, generally obtained in gypsum or dental plaster or stone
   Die: An individual replica in dental stone, part of a master cast and it can be repositioned.
   Mould: The chamber in which the molten alloy will be injected during the process of casting

To invest: To cover with a layer

Investment: The material to cover something with

Refractory investment: Heath resistant materials that are used as moulds to receive the molten alloy during the casting process, the setting hygroscopic expansion as well as the thermal expansion compensate for the shrinking of the alloy during the crystallization and solidifying phases.

Refractory cylinder: A solid limited by a cylindrical surface and two parallel planes segmented by the generatrices. It is formed when the refractory material is poured while in a liquid state that will crystallize in the flask.

Refractory cylinder crucible: An end of the cylinder which is conformed with the characteristics of the crucible former when the liquid refractory material crystallize in the flask.

Flask or vase: It is composed of two elements, the ring and the crucible former, if the ring is made of plastic, a cylinder without a metallic ring can be obtained since the plastic can be removed, if the ring is metallic it cannot be removed. In both types of ring, the cylinders are no more than 60 mm in length in the existing systems.

To cast: The method to reproduce an object by means of a mould.

Casting machine: A device designed to impale the molten metal to the interior of the refractory cylinder mould. The most common device is a centrifugal machine which generally has two articulated extensions, one of them is a counterweight intended for balancing and the other has an adjustable plate that holds the crucible for melting the alloy and a casting ring holder. The refractory cylinder will be placed with its crucible aligned so that it faces the melting crucible.

There are also more sophisticated machines intended to melt the alloy by induction processes and force the molten metal either by air pressure or vacuum.

Casting machine crucible: A refractory rectangular tray with a hollow receptacle and a funnel located on one of the extremes. The hollow receptacle will receive the alloy to be molten and the funnel will function as a corridor for the expulsion of the molten alloy which will enter the mould via the refractory cylinder crucible.

Base or support (Sprue former). A simple or complex model of different forms and materials with many functions; a) support for mounting the patterns, b) sprue former to conform the entry duct in the cylinder crucible, c) compensation chamber or reservoir to compensate for the crystallization shrinkage, d) sprue former to the patterns that will connect the ducts to the patterns.

Obviously, the terminology of the system of the invention does not exist, in the description of the invention an effort was made to find the more adequate terms to be revealed in the description.

Thermal Zone

With the purpose to understand the differences, the rationale for the design, the shape, dimensions and position of the supports in the cylinder of the present invention, we have to consider the thermal zone of the refractory cylinder, that is, the warmest zone corresponding to the geometrical axis and its closest zones, and a less warm region located in the external surface and the zones close to it; all of this is related because when the refractory cylinder is taken from the furnace after the contents of the cylinder had been burnt out to conform the mould, it begins to cool from the surface towards the center, even though this happens in a few seconds during the transportation from the furnace to the cylinder holder of the casting machine just before the molten alloy in the crucible is injected trough the thermal zone which is the sprue former located in the cylinder axis. This determines that the molten alloy will crystallize in this zone after the alloy in the patterns located peripherically and near the surface (cool zone) pushing the still molten alloy to the patterns and compensating the effect of sucking or shrinking inherent to all alloys during the solidifying phase. We achieve in this way an unidirectional guided crystallization that maintain the structural characteristics like the distribution and grain size as well as the physical properties of every alloy. This compensation is essential in the precision and fit of the prostheses, having in mind that we are talking of microns.

Another advantage of the system is that the gases will escape not only via the cylinder crucible but trough all the surface of the cylinder due to the proximity of the patterns to the external area.

The big error in all existing systems is to consider the location of the thermal zone in a position that does not correspond to its shape, it has been considered that the thermal zone in a cylinder is located horizontally.

Even though it is well known that the location of the thermal zone in a refractory cylinder coincides with the geometrical axis and this should be the basis for the design and orientation of the sprues, this has not been considered and the ducts have been oriented in a T bar design and others, in a very disadvantageous position considering a horizontal thermal zone highly compromised in which the extremes of the horizontal bar (That will act as a reservoir) will be outside the thermal zone due to its proximity to the external surface of the cylinder (cool zone). Frequently the alloy will crystallize in this zone and avoids the alloy to fill the moulds of the prostheses, the results are catastrophic. This is then avoided by increasing the diameter of the cylinders but this means that great quantities of refractory material has to be used; with the main duct perpendicular to the horizontal bar in which the patterns are to be mounted with wide connectors, once the mould has been made, the alloy will change direction brusquely thus diminishing its velocity to fill the mould and provoking a turbulent flow resulting in defects of the final cast. The width of the sprues make it difficult to cut the casts and to calibrate them. Due to the wrong position of the support in the vase, it is only possible to mount the patterns in one plane (at the extreme of the cylinder) thus limiting the number of patterns to be made. The emission of ammoniacal vapors and other gases when the cylinders are in the burn out process to obtain the same number of castings as with the present invention is more than 700%, or what is the same, the savings on refractory material is more than 700%, this contributes to less contamination and savings of alloy, electricity, cutting and grinding instruments in the same proportion. It also solves the problem of sub-utilization of the cylinder because it is possible to mount 21 units in one of the supports of the system and 12 in the other support consuming only 160 g of refractory material, while in the existing systems up to 450 g of refractory material is used to invest a 6 unit bridge pattern. Another objective of the present invention is to considerably diminish working time and to obtain predictable and repeatable results.

More objectives and advantages of the invention are cited:
1 The design of the burnout supports (Sprue formers) equipped with round ended male attachments to mount 21 units in the type A and 12 in the type B, much more than any system in a limited space and small amount of time. A detailed description is included in this manuscript.
2 The 5 mm to 6 mm diameter is enough to serve as a reservoir to all the patterns
3 The satin finish facilitates the flux of the molten alloy
4 The type A support is designed to mount straight bridge patterns and or individual patterns
5 The type B support is designed to mount curved bridge patterns and individual patterns
6 The complement to mount individual patterns (beveled female attachment type (a) forces the technician to connect the pattern to the bevel in a tangential position which enables the molten alloy to have a laminar flow instead of a turbulent flow avoiding porosities (gas bubbles), tears and incomplete margins.
7 The tubular shape of the supports and connecting female supports avoid the fracture during burnout in the furnace
8 The cap in one of the extremes of the support avoid the refractory material to enter within the support
9 The slimness of the sprue formers and the connectors to the individual patterns in the type A and B support (rounded male attachments) and the bevelled female attachment as well as the sprue formers and connectors to the curved bridge patterns by means of the rounded male attachments and sticky wax increases the flow speed of the molten alloy that enters the mould thus respecting the premise in metallurgy that states that the mould should be filled as fast and as gentle as possible. Further details are included
10 The automatic seal of the stem of the support with the receptacle in the cone renders unnecessary to add wax because the seal is hermetic.
11 The mounting of the patterns in the support is made with the patterns always on the working dies or the master model, this assures that no distortion will occur, even in extreme climatic conditions.
12 The location of the supports within the vase is ideal, the reservoir is situated in the geometrical axis of the cylinder (thermal zone) and the patterns with the margins facing outwards in the cool zone, this determines a directional guided crystallization to compensate for the hardening shrinkage of the alloy
13 The gases escape not only trough the cylinder crucible but trough all its the surface, this avoids a counter pressure and the negative effects like porosities or incomplete filling of the mould
14 The cylinder crucible former has two domes opposing each other and separated by the cone that will act as two channels to promote combustion and escape of the material during burnout
15 It facilitates for an hermetic seal due to the novel design of the cylinder crucible former with a notch deep enough to allow for the insertion of the bevel located in the narrower section of the flask or vase
16 The cylinder crucible former has a design that allows for easy removal of the casting ring due to a pair of flanges in the external side (An explanation and figures will be described)
17 There is a considerable amount of savings of approximately 700% and the flask or vase is utilized with both systems (A and B) to receive the refractory material during investing utilizing only 160 g, in comparison to the use of T bar supports this means a 700% less material used.
18 The horizontal mark in the ring requires only 120 g of refractory material to be filled
19 The elasticity of the flask or vase allows for both the hygroscopic and crystallization of the refractory material thus helping to compensate for the contraction of the alloy during hardening
20 The flanges in the flask or vase facilitates the removal of the casting cylinder
21 This systems offers versatility because the typeB support allows to be curved or not, so multiple individual patterns or straight bridges can be mounted
22 No additional tools or materials are required to take this present invention to the practice, the male attachments can be bent to change direction with finger pressure and the female attachments (a and b types) remain in place even with the vibration of the investing process
23 The individual patterns can be gyrated in relation to the male attachments due to the ability of the female attachments to do so.
24 If not all of the support is to be used, it can be shortened and sealed with a hot instrument allowing for it to be covered with 5 mm of refractory material in the vase
25 The time for mounting each pattern is greatly reduced due to the male-female design. The diameter of the sprues (2 mm or less) allows for reduced time of cutting the castings
26 Retrieval of individual patterns is easy and fast due to the location of the sprues in one of the axial walls of the pattern, calibration also becomes easy without risk of perforation; in the case of bridges or splints retrieval, the sprues and the connection to the patterns is narrow so cutting and finishing becomes an easy task
27 Due to the amount of prostheses that can be fabricated in one casting ring, the quantity of both refractory material and alloy diminishes greatly, this helps reduce environmental contamination
28 In other aspect of the invention, the novel metal fixture designed to be attached to conventional centrifugal casting machines makes it possible to place large cylinders without altering the mechanical and functional original characteristics of the machine, thus making it versatile and convertible.

The Invention

This present invention refers to a modality of a system to optimize the manufacture of refractory moulds to fabricate multiple metal castings in dental fixed prostheses, another aspect of the invention is constituted by:

1. Two designs for sprue forming supports (One type A, one type B and two new designs of beveled female attachments (Type a and type b), the type a beveled female attachment is to be used in both A and B supports, the type b is intended for the type B support only.

2. A design of a vase is described composed by a crucible former and a designed modified ring to be inserted in the crucible former and create the vase

3. A novel metalo-mechanic component is described to modify horizontal conventional casting centrifuges in convertible machines to allow for the positioning of large (80 mm) casting cylinders.

The type A support (FIG. 2,3,4,8,9) is a burnout plastic tube that is 62 mm long, an external diameter 5 mm to 6 mm and 1 mm thick walls closed by a plug in one end, The plug may be of the same material or solid wax with the same dimensions and characteristics; from this tube arise troncoconical protuberances 2 to make a total of round-ended cylindrical fixtures 3 two to three millimeters long with acute angles distributed through and in the length of the support up to 47 mm leaving for al 5 mm long stem 4 The male attachments are distributed in four rows opposed two of them from another at the same level and denominated north and south while the other two (east and west) are located between north and south, each of the male attachments are located 8 mm. from each other.

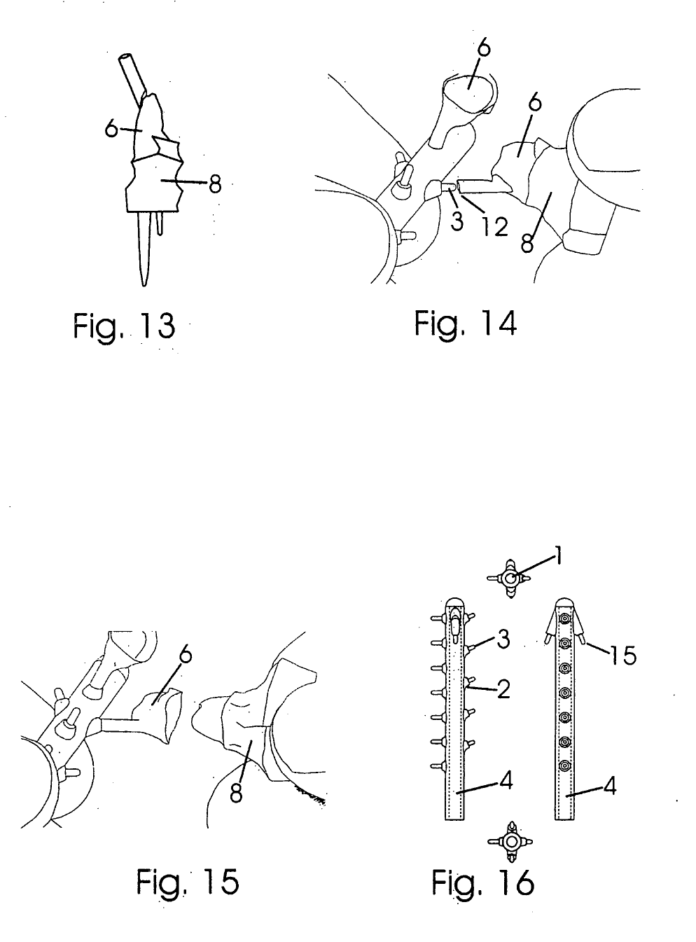

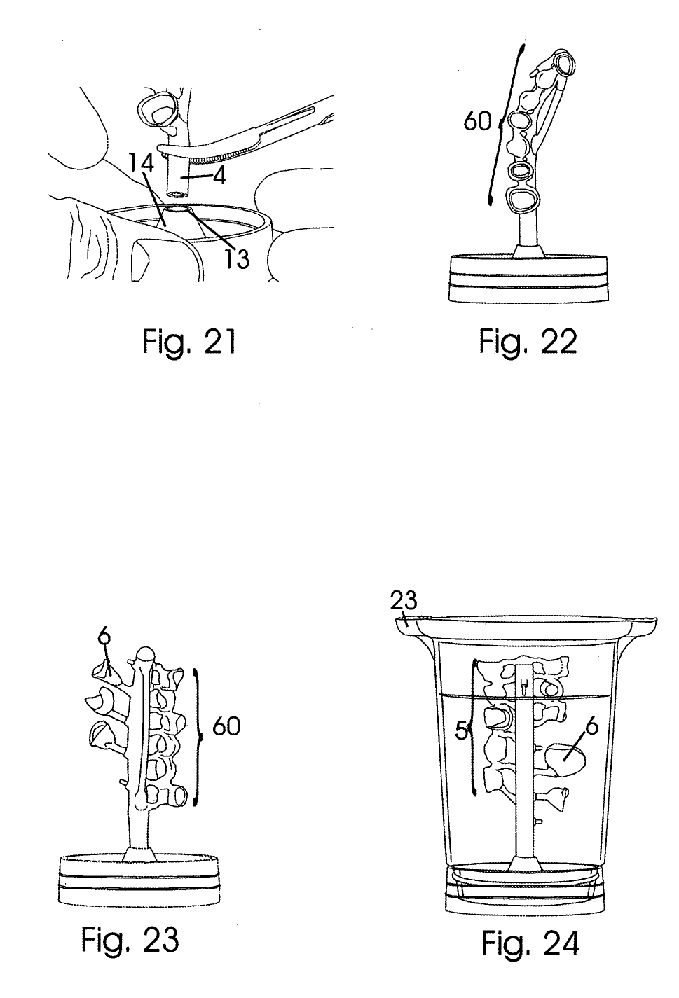

This support is intended to mount straight bridge patterns 5 and or single patterns 6. To attach straight bridge patterns 5 FIG. 2 sticky wax is utilized to connect the attachments 7 to the males 3 in the support while the pattern is still in the working dies 8 of the master cast 9. To mount single patterns 6 in either type A or B support FIGS. 8,16, the beveled female type a attachment is used FIG. 10 which is a tubular plastic component 5 to 6 mm long and 2 mm in diameter with a beveled end to be attached to the pattern with wax 6, FIG. 13 after having added a drop of wax 11, FIG. 12 just below the incisal or oclusal edge while the pattern 6 FIG. 11,12,13, is still in the working die 8 FIG. 13. The pattern is inserted 6 in the male attachment 3 of the support FIG. 14 trough the free end 12 of the female attachment and dislodging FIG. 15 the working die 8 from the pattern 6. The lower end 4 of the support is then inserted in the notch 13 of the cone 14 of the crucible former, FIG. 21 with a plies.

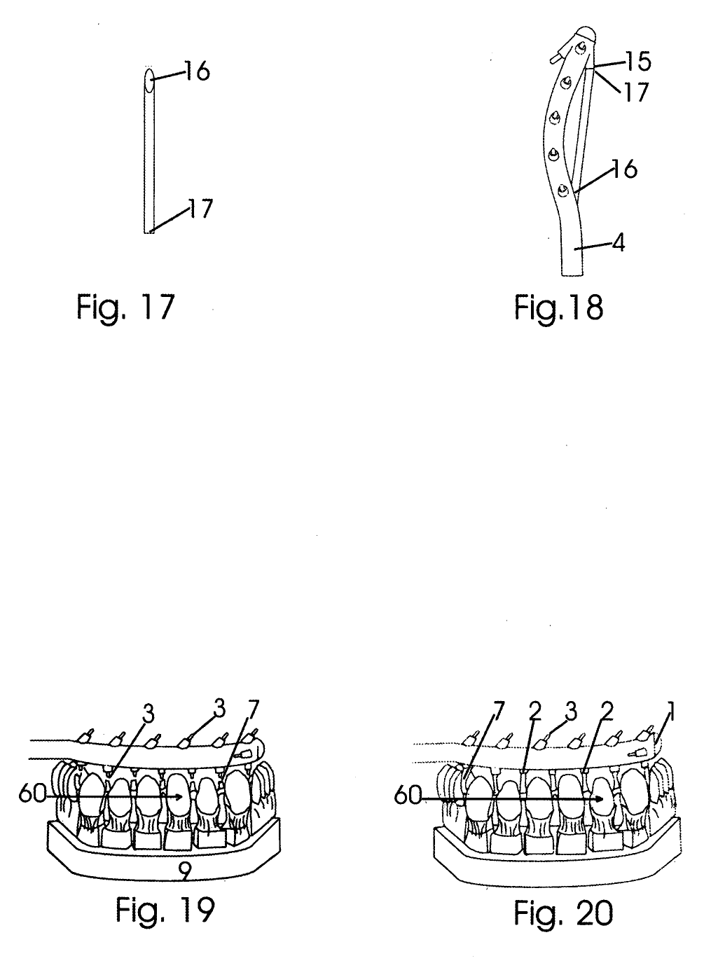

The type B support FIG. 16 is a burnout plastic tube 62 mm long, with a diameter of 5 mm to 6 mm and one millimeter in wall thickness with a closed end of the same or a support off solid wax with the same dimensions and characteristics. From the tube or bar emerge some troncoconical protuberances 2 from which round ended cylinders 3 two to three mm long and one mm in diameter arise in straight and acute angles in two opposite rows, the males in the north position are located in between the ones in the south position in 47 mm leaving a stem of 15 mm, from the blocked end 1 two male attachments five mm long 15 emerge in a down-out direction located in the east and west positions. The type (b) female attachment FIG. 17 is a rigid plastic tube 16 beveled at one end and is a fixing element to stabilize the curvature of the bent support to coincide with the curvature of the bridge pattern FIGS. 18, 19, 20. To install the type (b) female attachment FIG. 17 the non-beveled end is inserted in the male attachment 15 of the support, the beveled end 16, or attached to the stem of the support 4, FIG. 18 with sticky wax or burnout acrylic resin; once this set up is ready FIG. 18, the connectors 7 of the pattern are placed in the male attachments 3 of the support FIGS. 19, 20 with sticky wax. Then the pattern is dislodged from the master cast FIG. 20. Another row of male attachments can then be used to mount more patterns. The lower end of the support 4 is inserted in the notch 13 of the cone 14 of the crucible former as a sustaining element FIG. 21 A vase composed of two parts: the crucible former and the ring is here described

Crucible former, also mentioned as forming element because up to this moment it has been used as a base but in the subsequent steps will be utilized to give form to the refractory cylinder crucible.

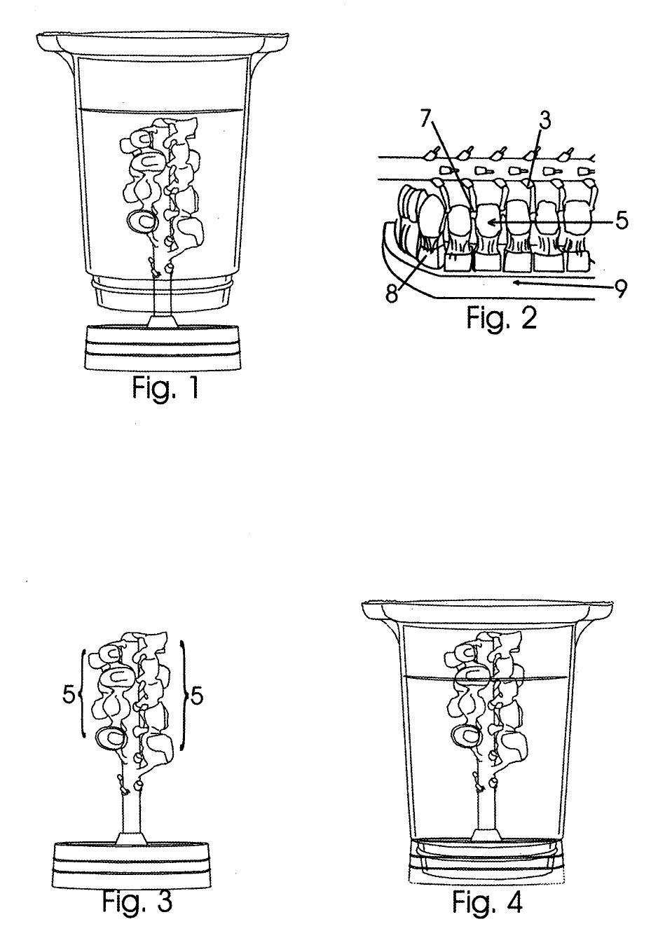

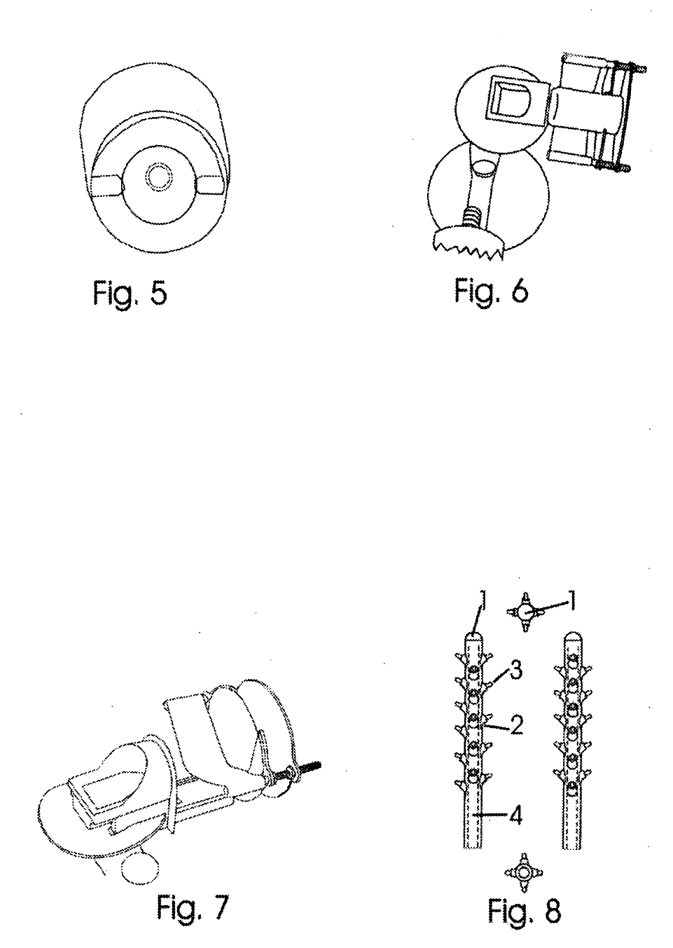

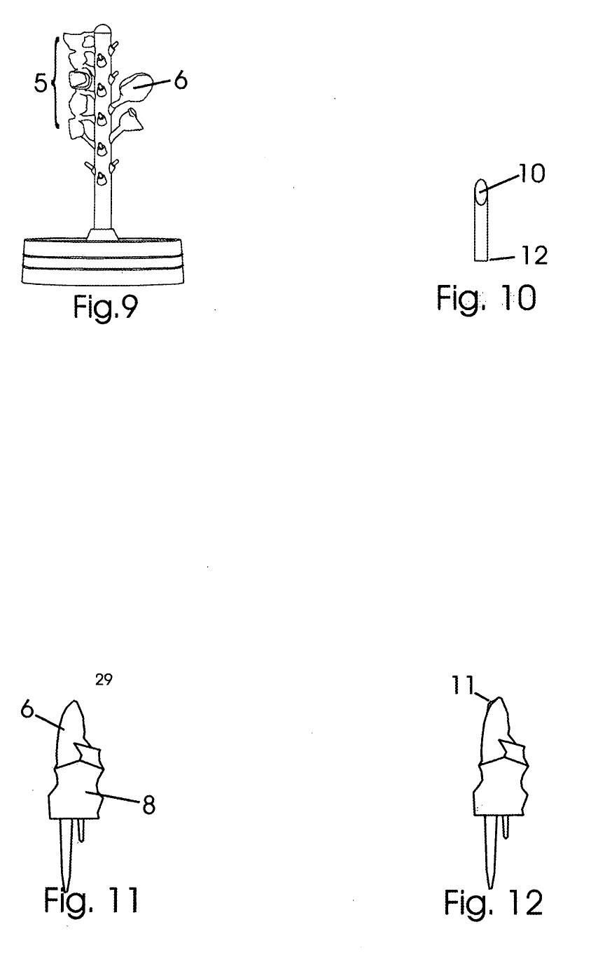

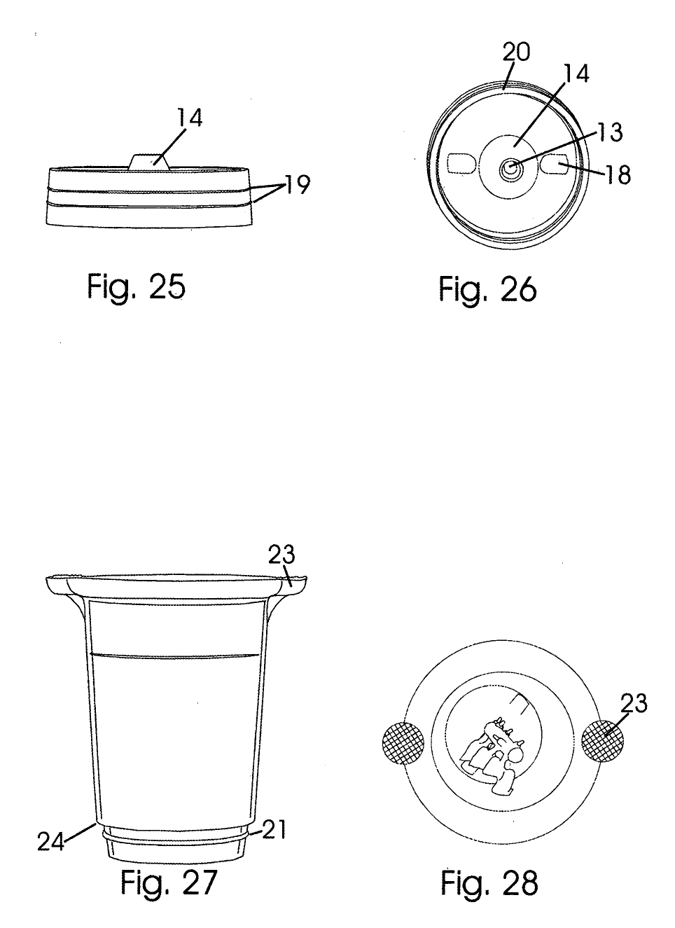

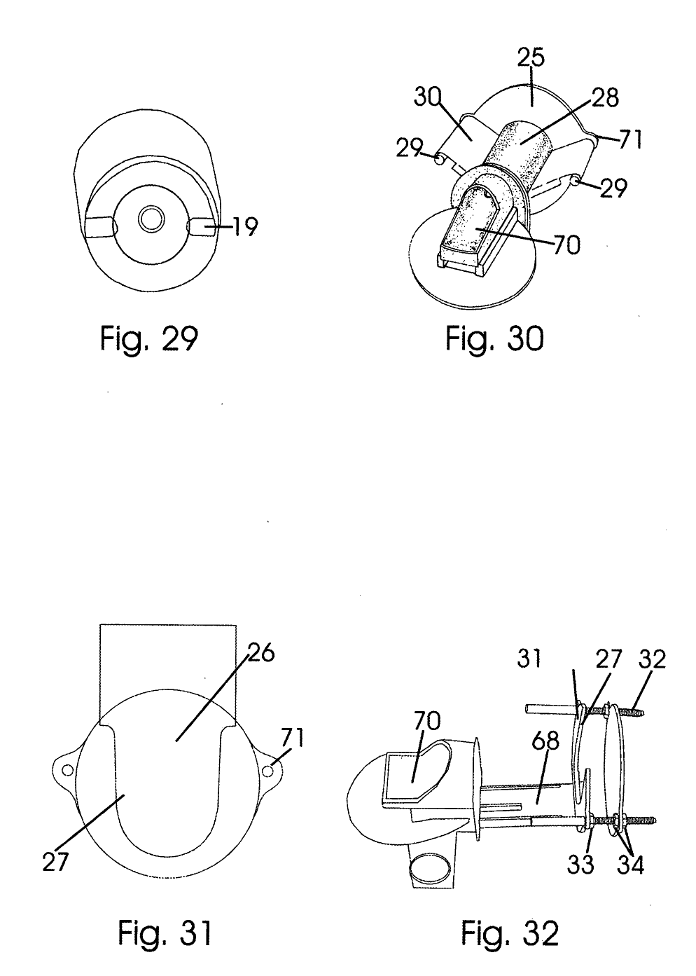

In FIGS. 21,24,25,26 the crucible former works as a base, however, it also acts a mould to give form to the refractory cylinder crucible and as the base or bottom of the vase once the ring is inserted. The crucible former, with a circular structure has in its upper face a conical protuberance 14 with a notch in its upper end 13 to receive the lower end of the support 4, it is also characterized by two opposed domes 18 opposed one to another and separated by the cone 14 as forming elements to provide two channels to the refractory ring crucible 19 FIGS. 5, 29 that promote combustion and venting to the refractory cylinder during burnout. It also has two parallel flanges 19 all around FIG. 25 the external wall to facilitate the removal of the ring FIG. 27, and in the internal wall it has a ditch 20 FIG. 26 to allow for the insertion of the ring 21 FIG. 27 and conforming the vase FIGS. 1,4,24.

The Ring

A plastic ring is described FIGS. 1,27,28. It has the characteristic of a high elasticity to allow for the setting expansion of the refractory material FIG. 27 and the disassembling of the cylinder. In its upper end it has two reinforced pointed ears that are opposed one to another to provide hold while dismounting the cylinder from the ring; in the lower end it presents a right angle step that thins this section of the ring which has a flange 21 relief to be inserted in the ditch 20 of the crucible former to complete the vase FIG. 24 and to be filled with liquid refractory material that, once crystallized, will be the refractory cylinder FIG. 29. Then, this cylinder will be dismounted from the vase and be subjected to high temperatures in the oven to burn out the contents leaving a mould to be filled with molten alloy

Metal-Mechanic Dispositive

As an indispensable part of the system a novel dispositive has been developed that allows to place longer refractory cylinders (80 mm) in the conventional horizontal centrifugal casting machines in comparison of preestablished 60 mm cylinders in order to obtain more dental castings in one single operation.

This dispositive includes:

Two metallic plaques, two screws, six bolts and a template.

Installation

The template 26 FIG. 31 is intended to delineate form and dimension of a notch 27 that will be performed in the original vertical plaque 25 FIG. 30 with external perforated flanges 71 to externally support the cylinder 28. The cylinder holder screws are removed 30 and are substituted by two screws 31 FIG. 32 with notches 32 to be fixated with two bolts 33.

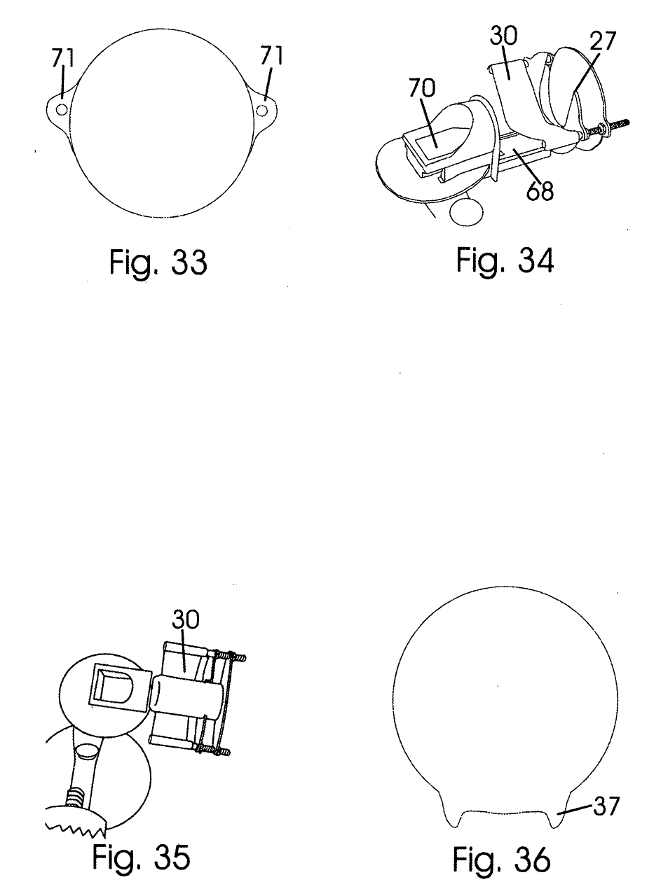

A replica of the original plaque FIG. 33, 32, is to be inserted trough the perforated. Ears or flanges in the notches of the screws, separated by 2 cm FIG. 32 and parallel to it and fixed with four bolts one on the outside and one in the inside in both screws allowing the positioning of large casting cylinders in the cylinder holder 30, FIG. 34 resting in the replica and trough the notch FIG. 35. The second rounded metallic plaque FIG. 36 has two inferior appendixes 37 and is utilized to cover the performed notch 27 FIGS. 31,32,34, it is mounted and stabilized in the rail of the arm 68 FIG. 32,34,7 of the centrifugal machine to give back the original mechanical and functional characteristics, that is, transforming it in a convertible and versatile casting machine FIG. 7.

In to what the process is pertained, a detailed description of the novelty of the Invention is described.
1. Wax-up. It is the manufacturing in wax and or burnout plastic of the pieces to be reproduced in metal alloy that is performed on the working dies of the master cast or model.
2. Preparation of the single patterns and the type B support for its mounting and connection. In individual patterns to be mounted in both type B and A supports a drop of wax 11 FIG. 12 is applied with a PKT instrument one millimeter below the incisal or occlusal edge in one of the axial walls of the pattern 6 while it is still on the working die 8, FIGS. 11,12. The beveled end 10 of the type (a) female attachment FIGS. 10,13 is fixed to the added wax. Then, the working die 8 FIG. 14 is taken and coupled with the male attachment 3 of the support by inserting the free end of the female attachment 12, the working die is pulled 8 to dislodge the pattern FIG. 15. The pattern will remain in the male attachment 3 of the support.
The type A support to mount straight bridge patterns and single patterns does not require for a special treatment
The type B support FIG. 16 is designed to connect with curved bridge patterns FIGS. 18,19,20 and requires to be bent with a plier to coincide with the curvature of the pattern and to stabilize this curvature with the type (b) female beveled fixation attachment that is inserted by its non-beveled end in one of the male attachments 15 FIG. 16 of the support, the beveled end 16 of the female attachment is secured in the stem 4 FIG. 18 of the support by means of sticky wax or burnout resin
Both the type A and the prepared type B supports will be connected to the bridge patterns as follows:
The round end male 3 FIG. 2, 19,20 attachments of the support are fixed with sticky Wax to the pattern connectors 7 (straight or curved) allowing a distance of 3 mm to 4 mm between the base 2 of the male 3 of the support to the connector 7 of the pattern; this complex (Pattern and support) is dislodged from the working dies of the master cast or model 9. This process is repeated in the available rows of male attachments in the support.
3. Securing the support in the crucible former FIG. 21 Once the patterns are connected to the support, the stem 4 is inserted in the notch 13 of the cone 14 of the crucible former FIG. 21
4. Forming the vase. This is achieved by inserting the ring FIG. 27 and coupling it hermetically in the crucible former FIGS. 1,24,25.
5. Investing the pattern and support complex. The liquid refractory material is poured in the vase, once it has crystallized the refractory cylinder will be ready with the crucible in one end FIG. 5,29.
6. Retrieval of the refractory cylinder from the flask. The crucible former is pulled by the flanges or ears 19 of the external aspect FIG. 25 and the ring is dislodged from the cylinder FIG. 27 holding one side by the crucible FIG. 5 and pulling
the other extreme by the ears of the ring.
7. Burnout of the refractory cylinder. The cylinder is subjected to high temperatures to calcinate the contents in it in order to provide a mould with an access and the crucible.
8. Casting. The cylinder is taken out from the burnout furnace at specific temperatures depending on the alloy to be cast, it is placed in the cylinder support of the centrifugal casting machine with the metal-mechanic dispositive previously installed. The alloy has already reached a molten state in the centrifugal machine crucible and the machine is activated to impele the alloy and fill the mould to form the metallic prostheses.
Retrieval of the prostheses. Is the removal of the refractory material and the separation of the connectors from the prostheses.
It has to be understood that the descriptions and figures are references to modalities of the invention and that an expert in the field can perform modifications by following the description and without deviating from the reach of the present invention.
The description of the invention has been made and is considered a novelty, therefore the following is to be claimed:

1. A system to optimize the conforming of refractory moulds for the fabrication of multiple alloy castings in fixed dental prostheses such as copings, crowns, onlays, inlays, straight and curved fixed bridges (up to half an arch) characterized by the development of a metal-mechanic appliance that is installed in conventional horizontal pivoting arm centrifugal casting machines to allow for the positioning of 80 mm or longer refractory cylinders to be casted to finish the process; the system is composed by two support types A and B in which the patterns will be mounted and are characterized by the presence of male attachments with a conical base and a cylindrical round end prong of a lesser diameter and a female attachment type (a) to be utilized in both types of support is single units are to be mounted and that is characterized by a resilient tube with a beveled end at one side, the type B support is also characterized by having two rows of round ended male attachments opposed one to the another, it is characterized because below the closed end of the support emerge two cylindrical extensions with a down and outside direction, each of the extensions has a smaller diameter prong that is longer that those in the rows, the complementary element of this support is the female curvature fixing attachment type (b) characterized because is a rigid tube with a bevel end, the system includes a crucible former characterized because it has two rectangular domes in its base, opposed one to the another, and relief flanges in the external aspect, the system includes a ring characterized by two circular pointed reinforced formations opposed one to the another and parallel horizontal markings in the external surface, the system includes a metal-mechanic appliance that is characterized by being composed by a carton jig plate, two bolts, six nuts, and two circular plaques, one with perforated ears and the another with low appendixes; all of these elements fabricated in the modality of stainless steel, the system is characterized because it has a natural influence in the process, including the installation of the metal-mechanic appliance.

2. System in accordance to vindication 1, the type A support is characterized by the presence of conical bases with smaller diameter round-ended cylindrical prongs emerging from them.

3. System in accordance to vindication 2, the type A support is characterized because it is designed for the mounting of multiple individual patterns and/or bridge or splint patterns with a very slight curve or none at all, this type A support is never to be curved.

4. System in accordance to vindication 1, the type (a) female attachment is characterized by a resilient tube with a bevel at one of the extremes which is to be connected in a tangential way to an axial wall of the pattern while this pattern is still in the working die to ensure the absence of deformation.

5. System in accordance to vindication 1, the male-female complex that constitutes the sprue former between the pattern and the support, considering not only its form but the function as well is characterized because it increases the speed and determines the type of flow of the molten alloy while it enters the mould, in this case is a non-turbulent flow that is known in the field of Fluid Mechanics as a laminar type flow, this kind of flow is of great importance because it means no porosity, lesser changes in the molecular structure of the alloy thus preserving the physical properties of the alloy and it complies with a premise in Fluid and Casting Mechanics which states that the molten alloy should fill the mould as fast and as gentle as possible.

6. System in accordance to vindication 5, once the beveled end of the type (a) attachment to the pattern without removing this from the working die is characterized because the free end will be guided to the round end of the male support which is more rigid than the resilient tube of the female, then, it can be easily inserted and automatically a hermetic fit is achieved.

7. System in accordance to vindication 3, the type A support is characterized because bridges with a slight curvature or no curvature at all can be mounted in it, the mounting is be performed by means of sprue-formers characterized because their diameter do not exceed 1.5 mm and are no less than 4 mm long, sprue-formers that go from the male attachments to the connectors in the patterns, never to the incisal borders or occlusal aspect

8. System in accordance to vindication 1, the type B support is characterized by only two rows of round ended male attachments opposed one row to another, from the closed end of the support two opposing cylindrical bases emerge, one of each with round ended prongs with a smaller diameter directed downwards and outwards.

9. System in accordance to vindication 1, the type B support is characterized because it is specially designed to be curved and allow for curved bridges and single patterns as well to be mounted in it, its complement is the curve fixing female type (b) attachment characterized because it is a rigid tube beveled at one end.

10. System in accordance to vindication 9, the mounting of the curved bridge patterns is made trough the utilization of the sprue formers characterized because their diameter do not exceed 1.5 mm and are no less than 4 mm long, always from the male attachments and to the connectors in the patterns.

11. System in accordance to vindication 9, the type B support is characterized because of it versatility, if not bent it can be used for the mounting of single patterns and/or straight or slightly curved bridge patterns

12. System in accordance to vindication 1, the crucible former is characterized by having two rectangular domes opposed one to the other in its base that will give origin to two funnels in the refractory cylinder crucible to facilitate the gas exhaust and the escape of the materials in the cylinder during the burnout process, it is also characterized by the flanges in the external aspect.

13. System in accordance to vindication 1, the ring is characterized because it has two pointed and reinforced circular prongs that are opposed one to the other.

14. System in accordance to vindication 1, the metal-mechanic appliance is characterized because it is composed by a jig plate in the modality of carton; 2 bolts, 6 nuts, a circular plaque with perforated ears and a circular plaque with lower appendixes, all of the above in the modality of stainless steel.

15. Process for the fabrication of fixed dental prostheses by the utilization the system of vindication 1 to 14 that includes: the lost wax method, wax-up, which is the fabrication in wax and/or diverse clean burning materials of the patterns that are to be reproduced in alloy, this fabrication is performed on the working dies of the master cast, the next step in the process is the preparation of the patterns to be connected to the bevel of the type (a) female attachment characterized by the addition of a drop of resin or molten wax in one of the axial walls to immediately place the bevel on the added material in an always tangential position until it polymerizes or hardens, the second stage of the process is characterized because the connection of the pattern to the support is performed trough the free end of the resilient female attachment inserting it in one of the male attachments available in the four rows of the type A support or the two rows in the type B support obtaining automatically a stable and hermetic connection, then, the pattern is dislodged from the die; the straight or slightly curved bridge patterns are mounted un the support by means of the sprue formers characterized because their diameter is less than 1.5 mm and are no shorter than 4 mm always from the support male attachments and to the pattern connectors and are made with plastic materials or waxes; the type B support in a modality of resilient memory plastic is characterized because it is prepared bending it with a plier or immersing it in boiling water for some seconds, retrieving it and bending so its curvature is in accordance to the curvature of the pattern, the hands can be protected with surgical gloves, without releasing the support it is then submerged in cold water to keep its curvature, immediately, the fixing type (b) female attachment is mounted in one of the male fixing attachments and with a red hot PKT 1 type instrument both attachments are fused together, the connection can be made flush with resin or wax, the beveled en of the female attachment is then fixed to the support stem by the same procedure of fusing and flushing, in the modality of plastic wax support, this is to be curved manually and the type (b) female fixing attachment is inserted in one of the fixing male attachments and the other end is connected to the support stem with wax, another modality of fabrication is with preformed hollow plastic supports, closed at one end, in this case it is only a matter of selecting the most likely support; the pattern mounting stage is performed by means of sprue formers to the patterns characterized by having a diameter of less than 1.5 mm and are no shorter than 4 mm and always go from the support male attachments to the pattern connectors; the next step is weighing, before inserting the support stem in the crucible former it has to be weighed with the attached patterns in a scale and the weight has to be multiplied by the specific weight of the alloy to be used to know the amount of alloy to be molten in the casting machine crucible; the next stage is investing, once the ring has been inserted in the crucible former to form the vase, refractory material is poured and allow for it to crystallize, the crucible former is then pulled by the flanges to separate it from the ring and then the cylinder crucible can be observed as well as part of the support stem and the two funnels to allow the escape of gases and materials during burnout, the crucible is then pushed with the thumbs, the index fingers are firmly holding the circular pointed reinforced flanges in the ring to facilitate removing the cylinder from the ring.
Before placing the cylinder in the furnace it is taken to the support of the centrifugal machine and then the crucible with the alloy in it is placed in the machine to balance it, then the burnout process is performed at the temperatures and times specified, once this has been achieved, the alloy is molten in the casting machine crucible, the cylinder is taken out from the furnace and placed in the casting machine support and the centrifugal machine is then activated, the mould will be filled with the molten alloy which will then crystallize and form the casted object; the fabrication of multiple prostheses in conventional horizontal centrifugal pivoted arm casting machines would not be possible without the invention of a metal-mechanic appliance created to make them compatible with the utilization of long refractory casting cylinders recommended in this system, the metal-mechanical appliance is to be installed in the following way, a) removal of the ring support holders, b) the jig plate is to be used to measure form and dimension of a notch to be performed in the original vertical plaque with perforated ears, c) two bolts are to be inserted in the perforations, they will be projected to the outside and will be fixed with two nuts until they exert pressure to the plaque, d) two nuts will be inserted at the same distance from the vertical notched plaque, one in each bolt, e) the metallic plaque with perforated ears (replica of the original) is inserted trough the bolts until the nuts are reached, f) another pair of nuts is inserted in the bolts to fix and stabilize the replica between the four nuts; if the original mechanical and functional characteristics are to be recovered, it is easy to mount the plaque with lower appendixes in the rail of the arm of the machine to cover the notch, this converts the machine in a convertible and versatile centrifugal; the last stage is the recovery of the cast from the refractory cylinder utilizing stone scraper pliers, abrasive air or sandblasting and burs and it is extremely easy to separate the prostheses from the support by cutting the connections with a disk, calipering is also easy to achieve due to the fact that the connectors were placed in the axial walls of the prostheses in the case of individual patterns; in relation to the connectors to the bridges, the slim connectors are always directed from the support male attachments and to the connectors of the prostheses, thus the occlusal aspect is never touched nor are they bruised.
